(19) United States
(12) Patent Application Publication
(10) Pub. No.: US 2012/0317506 A1
(43) Pub. Date: Dec. 13, 2012

(54) Method and System for Executing a Graphics Application

(75) Inventors: Yunpeng Zhao, Gentilly (FR); Thomas Baudel, Gentilly Cedex (FR)

(73) Assignee: INTERNATIONAL BUSINESS MACHINES CORPORATION, Armonk, NY (US)

(21) Appl. No.: 13/580,283

(22) PCT Filed: Apr. 26, 2011
(86) PCT No.: PCT/EP2011/056523

§ 371 Date: Aug. 21, 2012

(30) Foreign Application Priority Data
Jun. 4, 2010 (EP) 10305601.6

(51) Int. Cl. G06F 3/048

(52) U.S. Cl. 715/764

(57) ABSTRACT

A system, program product and method of executing a predefined graphics application on objects belonging to a rendered image. The method comprises receiving an array of properties representing properties of the image objects and a mapping data structure. The mapping data structure maps pixel locations in the rendered image to indices in the array of properties. In response to the reception of a user input identifying the location of a given object in the rendered image the method comprises the following steps: (i) determining from the mapping data structure an object index for the designated object using the location of the given object; (ii) retrieving the properties of the designated object from the array of properties at the object index; and (iii) executing the predefined graphics application using the properties determined in step ii for the designated object.

### CROSS-REFERENCE TO RELATED APPLICATION(S)

This application is a continuation of and claims priority under 35 U.S.C. §371 to International Application No. PCT/EP2011/056523 filed on Apr. 26, 2011, which claims priority to EP 10305601.6 filed on Jun. 4, 2010. The contents of both aforementioned applications are incorporated herein by reference.

### FIELD OF THE INVENTION

The present invention generally relates to graphical display of data and more specifically to a method and a system for executing a graphics application on rendered objects.

### BACKGROUND OF THE INVENTION

In the past decades, a number of techniques have been developed to optimize interactions between the user and web applications through graphic interfaces, and allow the user to run a number of web applications by manipulating graphic images on the computer graphic interface using control input devices (cursor control keys on the computer keyboard, a pointing device such as a mouse, etc).

Thin client technology is one known approach that provides such rich interactive graphic functionalities. According to thin client technology, a web server generates the graphics and sends them as images to the client, without requiring client-side deployment, or relying on external technologies, while providing legacy browser support. Thin client technologies provide however limited interactivity on the client: each time the user clicks or performs a graphical interaction, a round trip to the web server has to be performed to provide an updated representation of the display. This allows generation of a display containing a bitmap image consisting of a number of graphical objects, such as for example a representation of a user-editable workflow network having a number of nodes. The user may then click or hover over a rendered object using a control input device to highlight or select this object and display related information. However current thin client based solutions require sending to the server the coordinates of the point clicked by the user, having the server compute the object that corresponds to this point, and returning a newly computed image representing the highlighted or selected object, as well as the application data associated to this object. This greatly reduces the interactivity of thin client solutions.

Other existing techniques for presenting dynamic graphic applications on the web rely on loading on the web browser some form of program that will be executed on the client side to create a graphic representation, react to user events and refresh the display accordingly. This can be performed either using proprietary technologies that require custom software installation on the client (deployment) such as Flash, Silverlight or Java Applets, or using web standards, such as HTML5, which are not available on the mostly used client web platforms, such as Microsoft Internet Explorer.

US 2010/0031196 provides a method and apparatus for selecting and highlighting objects in a client browser. The approach taken in US2010/0031196 is to encode the location of graphics object identifiers into a run-length encoded bitmap so that each pixel in the bitmap corresponds to a graphic object identifier. A local script is then used on the client to highlight or select (i.e. show the selection) the objects designated by the user using a pointing device. However, this solution lacks efficiency and wastes bandwidth. Further, this solution is limited to selection and highlighting of graphical objects and is not adapted to other thin-client applications.

### SUMMARY OF THE INVENTION

According to the present invention there is provided a method of executing a predefined graphics application on displayed objects according to the appended independent claim 1, a computer program according to the appended claim 10, a computer readable medium according to the appended claim 11 and a system according to the appended claim 12. Preferred embodiments are defined in the appended dependent claims 2 to 9.

The invention thereby provides richer graphical interaction capabilities for web applications, without requiring client-side deployment, including on legacy web clients.

The invention further enhances graphical interaction without requiring server round trips by generating an additional bitmap whose color indices actually designate application-domain objects and sending it to the client, together with associated information on the objects being depicted by the bitmap.

Accordingly, client-side scripts can retrieve information relative to the domain objects represented on the display and their geometry. This allows providing a variety of graphic applications on the client without requiring maintenance of a graphical data structure or frequent communication with the associated web server. With the invention, graphic applications cannot only locate the graphic representations corresponding to user input and retrieve shape information, but also have access to additional information on the client, such as object names, various attributes such as tooltips, state information (e.g. enabled, movable . . . ), and allowed actions attached to these objects (e.g. clickable button), identify if the object can be resized, or drag-and-dropped onto another one. Exemplary graphic applications includes without limitations semantic graphical feedback, such as tooltips, highlighting and selecting graphical objects, accessibility features, such as generating textual or audio representation of rich images.

Further advantages of the present invention will become clear to the skilled person upon examination of the drawings and detailed description. It is intended that any additional advantages be incorporated herein.

### BRIEF DESCRIPTION OF THE DRAWINGS

Embodiments of the present invention will now be described by way of example with reference to the accompanying drawings in which like references denote similar elements, and in which:

FIG. 1 shows an exemplary hardware architecture used to implement one or more embodiments of the invention;

FIG. 2A shows a detailed view of the system for executing graphics applications in accordance with certain embodiments of the invention;

FIG. 2B shows an exemplary representation of a bitmap structure, of a mapping data structure (“hitmap”) and of an array of properties (“hitlist”);

FIG. 3 shows the flowchart that describes the steps performed to trigger a graphics application on a rendered image;

FIG. 4 shows the flowchart for the “hitmap” and “hitlist” data structures generation in accordance with certain embodiments of the invention;

FIG. 5 shows the flowchart for updating the display;

FIG. 6 shows the flowchart for the object properties retrieval; and

FIG. 7 shows the flowchart for the graphical object shapes retrieval.

### DETAILED DESCRIPTION

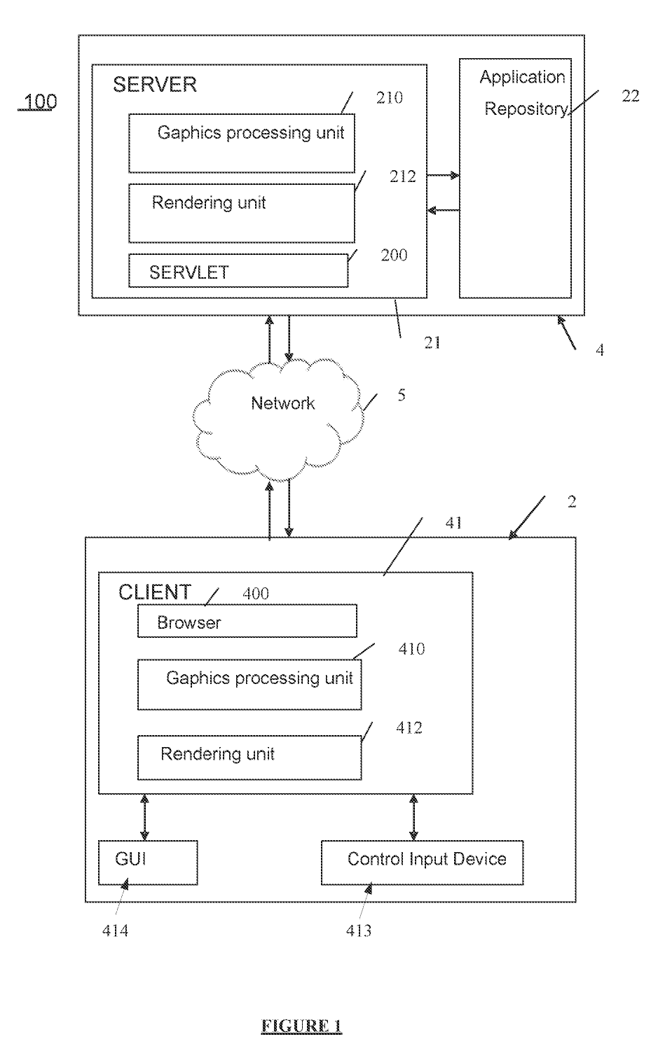

FIG. 1 illustrates an exemplary hardware architecture 100 in which the present invention may be practiced.

The architecture 100 is a client-server architecture comprising a server system 2 and a client system 4 connected over a network 5 for generating data display corresponding to the execution of the graphics application.

The server system 2 comprises one or more servers 21 for executing a graphics application from data stored in an application repository 22, such as a database or middleware software.

The client system 4 comprises one or more clients 41 for rendering images on an output device, such as a display or screen, including a graphical user interface (GUI) 414, based on data received from the server system 2.

It should be noted that although figure shows only one server 21 and one client 41, the system of the present invention supports any number of servers and client computers connected via network 5.

The graphics application data are retrieved from the application repository 22 by the server 21 to create interactive views. The server system 2 is provided to associate graphic objects with chosen application data objects and place them in a view data structure that the application framework provides by means of graphic toolkits functions. The server 21 communicates with the application repository 21 to retrieve application data or update data according to user requests.

The graphics application may be any type of graphics application that is adapted to apply a function on a graphical object such as a diagram editor allowing the user to access and edit UML diagrams, a plant monitoring application displaying a map of the plant, with super-imposed controls of various control devices, allowing the user to pilot the plant from a remote console. This may be in particular a web application programmed on the server like a regular interactive graphic application. The following description will be made with reference to such a web application for illustrative purpose only even if the invention may apply to graphics applications available through any type of network that ensure communication between the client side and the server side.

The server 21 comprises a graphics processing function 210 including a CPU (central processing unit) on which the graphics application executes based on a graphics API. The server system 2 further includes a rendering function 212 (e.g. a graphics card including a GPU (graphics processing unit)) for rendering the output of the graphics application to the client system 4. The server system 2 further includes a network interface (not shown) for transmitting the application data to the client system 4 via the network 5.

The client 41 includes a graphics processing function 410 for processing graphics application data from the server system 2 over the network 5 and a rendering function 412 for rendering the received graphical data on the user interface. The client 41 further includes a network interface (not shown) for exchanging data with the server system 2 via network 5.

The graphics processing function 410 may include a CPU and graphics API.

The rendering function 412 may include a graphics card. The rendering function 412 is provided to scale the coordinates of objects to match the display area on the graphical user interface 414, render visual elements such as shapes/icons, represent graph objects, and relationships between objects.

The graphical user interface 414 is adapted to display the result of the graphics application executed on the server system 2 and receive user inputs.

A client user may select any rendered object that is part of an image displayed on the graphical user interface 414 using any type of control input devices 413 such as cursor control keys of the computer keyboard, a pointing device such as a mouse, etc.

According to preferred embodiments of the invention, the server system 2 may rely on a web server infrastructure and includes web server software for hosting a number of servlets 200 executing on server 21 to implement features of graphical web applications communicating with client browsers.

In such preferred embodiments, each client 41 includes a browser 400 to allow the user to designate given objects on the user interface for execution of a graphics application and sending that request into the network for processing. The request reaches a servlet 200 running on the server 21. A servlet is a program typically written in the Java object-oriented programming language (Java is a trademark of Sun Microsystems, Inc).

The servlet 200 is adapted to answer specific queries from the web client 41 in the client-side part, and to deliver web content in the form of HTML pages embedding some scripts (written, for instance in the JavaScript programming language) and the images of application domain objects generated on the client graphical user interface 414.

The servlet 21 is adapted to receive an application request from the client with object data corresponding to the selection of a given object on the user interface, execute the application on the selected objects, and format the results into an HTML data stream. This HTML data stream is then sent back to the client 21, where the browser 200 processes the HTML to display the formatted results to the user on the user interface 414.

The servlet 200 may operate according to any suitable graphic language such as Java AWT to generate images representing application domain objects in a variety of standard formats such as PNG, JPEG or GIF.

The server 21 communicates with the application repository 22 to retrieve application data or update data according to client requests.

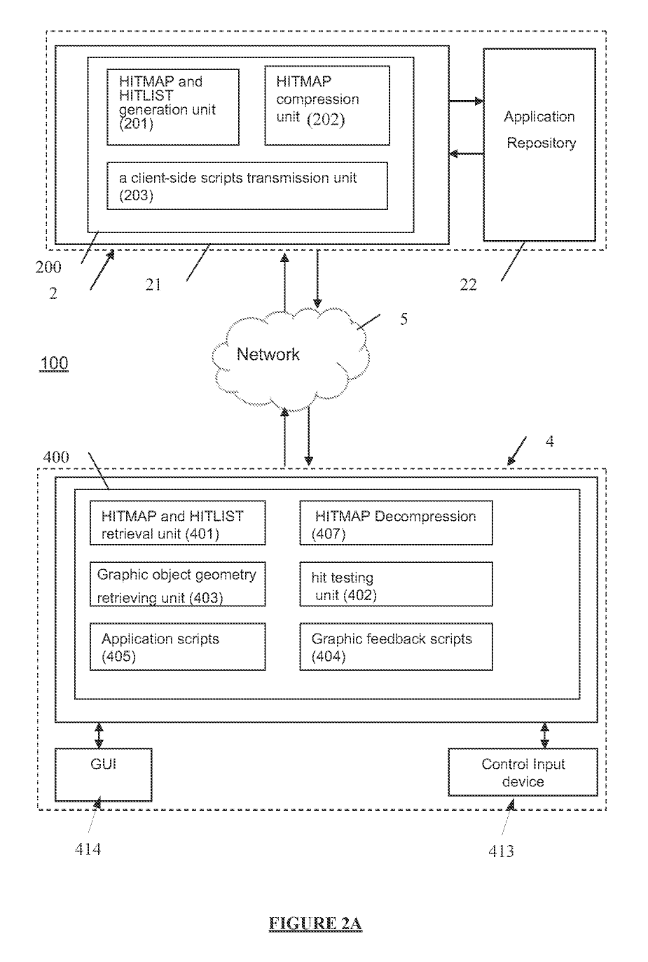

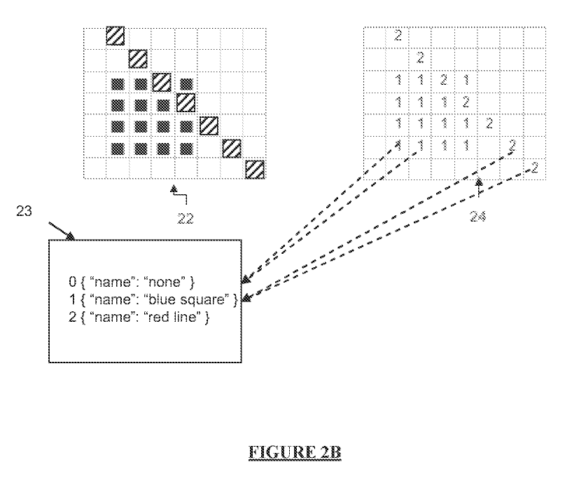

FIG. 2A illustrates in more detail the structure of the system 100 for executing an application in response to a user selection on the displayed image, in accordance with certain embodiments of the invention.

More specifically, the servlet 200 comprises a hitmap and hitlist generation unit 201 for generating a mapping data structure referred to thereinafter as a HITMAP and an array of properties referred to thereinafter as a HITLIST representing properties of rendered object. The servlet 200 further comprises a hitmap compression unit 202 for compressing the hitmap data structure and a client-side scripts transmission unit 203 for transmitting scripts to the client system 4 including the hitmap data structure and the hitlist data structure though network 5.

In accordance with the embodiments of the invention, the Hitlist data structure designates a list/array of data properties associated with portions of a bitmap presented to the user by the application. The bitmap is attached to the rendered image. The Hitlist data structure may be an ordered list of objects (e.g. JSON objects), where each object comprises a list of named attribute and value pairs. Those attributes and values may be chosen by the application developer. For instance, in the example of an UML diagram, they will describe the UML entities shown in the diagram, such as its name, type, or other UML-specific attributes.

The Hitmap data structure designates a data structure in the form of a matrix of integer values, stored in a format similar to a bitmap (e.g. PNG, GIF or other non-lossy compression formats). The hitmap data structure is generated in relation with the corresponding image bitmap presented to the user and the hitlist data structure. The integer values in the hitmap data structure at coordinate (x,y) represents the index in the hitlist of the object being represented at location (x,y) in the bitmap.

The client browser 400 includes a hitmap and hitlist retrieval unit 401 for retrieving hitmap and hitlist data structures from the server system 2, a hit testing unit 402 for testing hits and a graphic object geometry retrieving unit 403 for retrieving geometry of graphic objects using the hitmap graphical feedback of user input. The hit testing unit 402 is adapted to retrieve application data stored in the hitlist data structure that corresponds to the position {x,y} designated by the user.

It also includes graphic feedback scripts 404 to manipulate locally the HTML code of the page to provide local graphic feedback, and application specific scripts 405 that use the previous modules to implement the desired behavior of the web application. The client also comprises a HITMAP decompression unit 407 for decoding the received hitmap data structure.

The hitmap and hitlist generation unit 201 is provided to deliver representation instructions for augmenting a graphic representation of a raster image and communicate these instructions to the client 41 based on hitmap and hitlist data structures previously created.

In accordance with the embodiments of the invention, the mapping data structure (“Hitmap”) represents a data structure that maps pixel locations in the rendered image to indices in the array of properties (“hitlist”). The hitmap is based on a raster data structure comprising a matrix of cells (or pixels) organized into rows and columns (or a grid) where each cell contains a value representing information. Compared to a bitmap data structure that gives the color information of each pixel, the hitmap data structure gives the hit test information of each pixel of a displayed image.

FIG. 2B illustrates an exemplary image represented according to a bitmap representation at the left (22) and a hitmap representation at the right (24). The bitmap representation at the left shows two exemplary graphic objects: a red line represented by the hashed cells and a blue square represented by the black cells. The bitmap representation 22 at the left shows how the color information is represented, while the second representation at the right 24 shows the hit test information of the same bitmap, where the number 1 indicates that the pixel belongs to the first graphic object (the blue square represented in black) and the number 2 indicates that the pixel belongs to the second graphic object (the red line with hashed cells). The hitlist data structure 23 corresponding to the bitmap and hitmap data structures stores relevant application data for the objects shown in the bitmap (name of the objects in FIG. 2B).

A Hitmap data structure can be considered as an indexed bitmap format. Given the x and y coordinates of the mouse position, it is possible to identify which graphic object the pixel (x,y) belongs to. With such hitmap representation, hit test can be done extremely fast. Conversely, considering the index of a given graphic object, it is possible to determine all pixels that belong to the graphic object. This provides a fast way to highlight graphic objects.

The Hitmap and hitlist generation unit 201 is adapted to render hitmaps using any suitable technique, and in particular any 2D drawing pipeline, such as Java2D drawing pipeline with a customized Raster Composite. Compared to a conventional raster composite that writes pixel color information to a buffer when rasterizing graphic objects, the Hitmap composite writes the index of the graphic object being rendered to the raster buffer.

For example, when rendering the “red” line represented in FIG. 2B, a conventional raster composite will mark the corresponding pixels as red, while the Hitmap composite will put the index of the red line—with a value 2 in the example—to the corresponding pixels.

When generating a Hitmap representation, the hitmap and hitlist generation unit 201 attaches the index of the graphic objects to the raster data structure (raster buffer) instead of attaching the color of the graphic objects.

The generation unit 201 is also adapted to generate the second data structure referred to as HITLIST. When the server 21 generates the hitmap representation, it uses a corresponding array of application data objects, thereinafter referred to as “hitlist array”. This hitlist array may be generated substantially at the same time as the hitmap.

The hitlist array is maintained by the server system 2 and may be transmitted to the client browser 200 together with the bitmap structure representing the image graphical representation and the hitmap data structure.

The hitlist array represents a list of tuples that contain selected data attributes that correspond to the graphic object being shown into the hitmap.

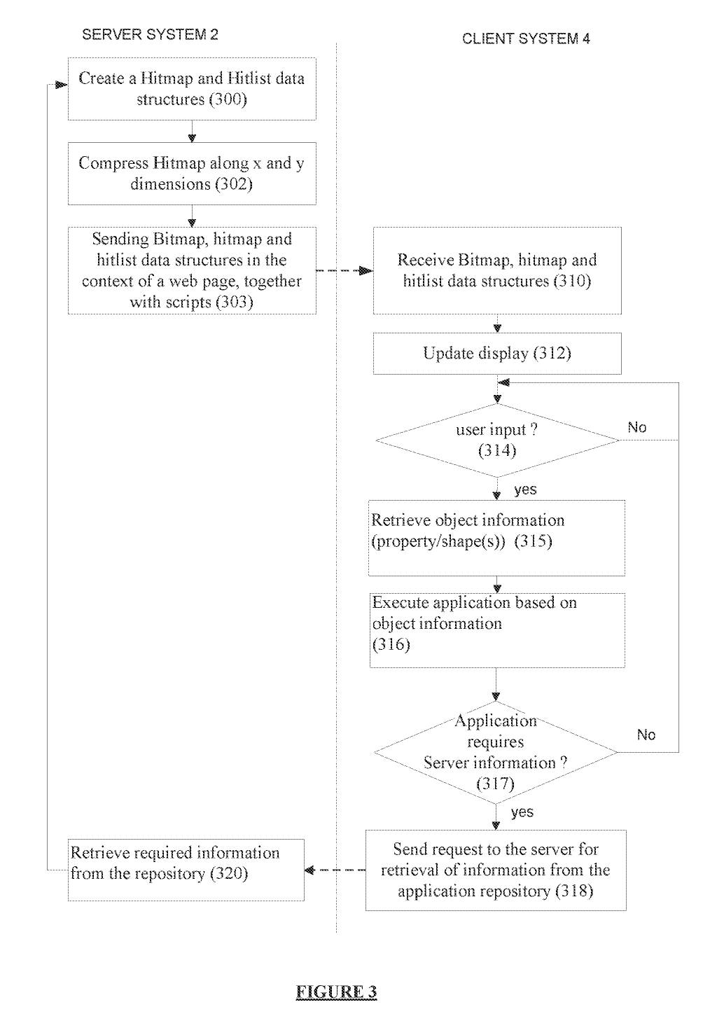

FIG. 3 is a flowchart of the steps performed by the system 100 to execute an application in response to a user selection on the user interface 414. The left part of FIG. 3 shows the steps performed at the server side, while the right part of FIG. 3 shows the steps performed at the client side.

In step 300, the server system 2 creates the hitmap data structure and the array of properties (Hitlist).

In step 302, the hitmap data structure is compressed along the x and y dimensions. Once generated, the hitmap data structure may be indeed as voluminous as the original graphic representation and involve some scalability problems as it may increase the bandwidth requirements between the client and the server. To limit the bandwidth requirements, a run-length encoding compression can be used. However, for representations that are rectangular in shape or are diagonal lines, run-length encoding is not adapted. Another solution adapted to these specific shapes may rely on the compression technique used in Portable Network Graphics (PNG), which provides more efficient compression by reducing entropy along both the horizontal and vertical dimensions.

Hitmap representation does not require the same resolution as the graphic representation to be effectively usable. Accordingly, to save even more bandwidth, the hitmap may be scaled down by an integral factor (such as 2) along the horizontal and vertical dimension. This reduces bandwidth used to convey the hitmap (up to 4 times less bandwidth). On the client side, the coordinates of the user events can be divided by 2 along both dimensions to retrieve the corresponding graphic objects when such hitmap scaling is performed.

In step 303, once the graphic representation (bitmap), the hitmap representation, and the hitlist representation have been generated, they are sent in the context of a web page together with scripts to be executed on the client browser to the client system 4 to implement the desired graphic application.

On the initial loading of the web page, all the data structures may be sent in one batch. Alternatively, a script function on the client-side may prompt the server for these structures on a per-need basis. Subsequently, when a user action requiring processing on the server system 2 is received (e.g. the user navigates to a web page in the client browser), the server 21 will provide the image bitmap, the hitmap data structure, and if needed the hitlist array of properties and the scripts enabling the specific graphic applications.

Turning back to FIG. 3, the client system 4 receives the graphic representation, the hitmap representation, and the hitlist representation from the server 21 in step 310.

The client-side software is then updated to enable interpretation of a user pointing event, in step 312.

In reply to a user input (user pointing event) designating an object of the rendered image (step 314) for execution of an application, steps 315 to 320 are performed to execute the application on the designated object.

The user pointing event is triggered by an input provided by the user through the user interface 414 using the control input device 413 to designate an object of the displayed image, for example by moving the cursor to the object location.

In step 315, object information is retrieved related to the designated object is retrieved using the hitmap data structure and the array of properties (hitlist). This object information comprises object properties and/or object graphic shape(s).

In step 316, the application is executed based on the information retrieved in step 315. The application execution may involve developer-defined scripts of various types, involving for instance displaying a tooltip, showing a shadow representation of the object to perform drag and drop, or other types of visual effects.

In step 317, it is determined if the application execution requires additional application information from the server. This may occur in some phases of the application execution (such as the end of a drag-and drop, for instance), where the application needs to retrieve data from the server or to notify of a data-change. If such data are needed, a request is sent in step 318 to the server. The server 21 then retrieves in step 320 the required application information from the application repository 22, performs the necessary updates, and repeats steps 300 to 304.

In most cases, the application will be able to execute without requiring more information than is the information maintained in the hitlist, and will not need to send information back to the server.

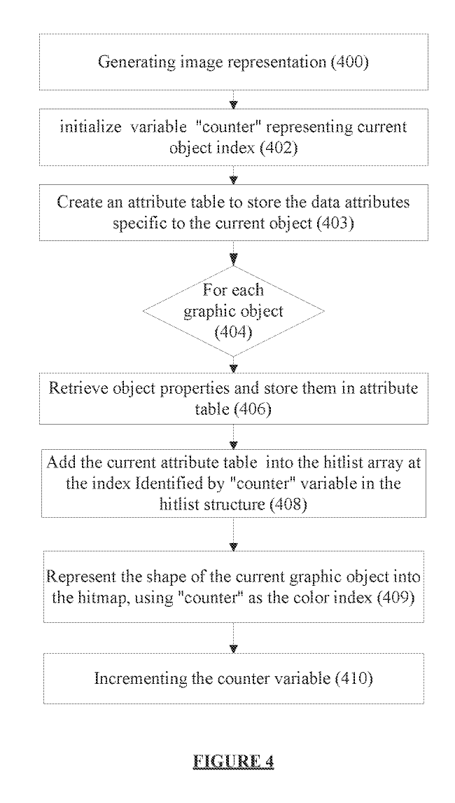

FIG. 4 is a flowchart for generating the Hitmap data structure and the hitlist array according to certain embodiments of the invention (step 300 of FIG. 3).

In step 400, the image representation is initially generated. This may be performed with the help of a graphic representation toolkit, such as Java AWT. A collection of application data objects is traversed, for instance, a UML diagram structure, and for each of those objects, corresponding shapes (in the case of UML diagram, these are rectangles, diamonds, links . . . ) are produced by means of the toolkit on a bitmap which will later be sent to the client.

Step 402 initializes a variable named “counter” to keep track of the current object index. The current object index will be used as a “color” index in the hitmap representation for the current object.

In step 403, an attribute table (attribute map) is created to store the data attributes specific to the objects being represented. This attribute table will then be serialized as a data structure to be transmitted to the client browser, such as for example a JSON data structure (JavaScript Object Notation).

Step 404 iterates over the graphic objects forming the represented image to generate the array of property (hitlist data structure) and the mapping data structure (hitmap).

Steps 406 iterate over the current object properties to retrieve and store its properties in the attribute table. For instance, if the application is representing a UML diagram, and the current object is a class, the object properties can comprise: the name of this class, its attributes and its methods, all being a collection of individual character strings.

In step 408, the current attribute table is added into the hitlist array, at the index having the current value of “counter” variable in the hitlist structure.

In step 409, the shape of the current graphic object is generated into the hitmap, using “counter” variable value as the color index. For example, if the current object has been represented at step 400, according to UML diagram, using a rectangular shape, then, at this step, the same rectangular shape will be reproduced into the hitmap, but using the “counter” value as a color index instead of the regular color used to represent UML classes.

Finally, in step 410, the counter variable is incremented to handle the next graphic object in the list.

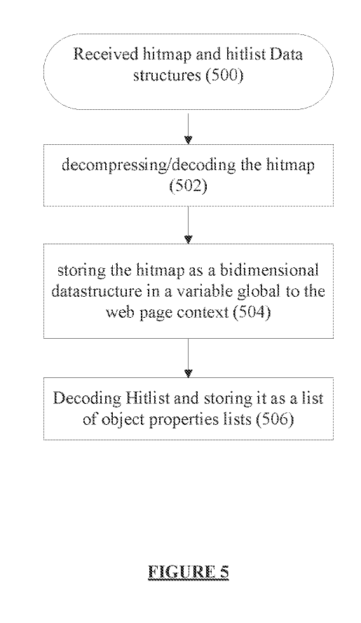

FIG. 5 is a flowchart showing steps performed by the client system 4 to generate or update the display (step 312 of FIG. 3).

The process starts in step 500 with the received hitmap data structure and the array of properties (hitlist).

In step 502, the hitmap data structure is decompressed/decoded using the reverse server encoding process.

In step 504, the hitmap is then stored as a bidimensional data structure in a global variable stored in the web page context of the client browser 400. Step 504 may be performed for example according to the JavaScript programming language and DOM (Document Object Model) which provides a possible mean to store and operate on such variables.

In step 506, the array of properties (hitlist) is also retrieved from its encoding (e.g. JSON) and stored as a list of object properties lists. This may be also stored as a global variable in the same web page context.

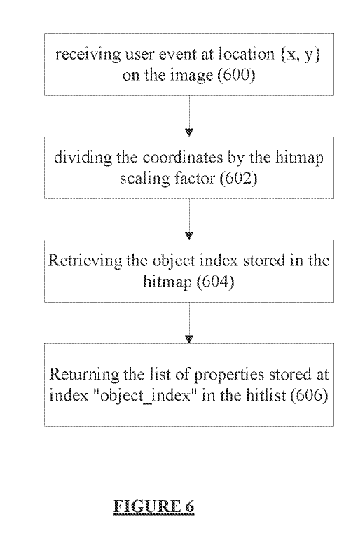

FIG. 6 is a flowchart for the retrieval of object properties in response to a user pointer event (step 315 of FIG. 3).

To retrieve the pixel color of a given point in response to a user pointing event, and from the color information, it is turned into an integer that is used to retrieve the application data associated with the area of the display the user has clicked on.

More specifically, upon receiving user pointing event at location {x, y} of the displayed image (600), the coordinates are divided by the hitmap scaling factor in step 602. In step 604, the object index “object_index” stored in the hitmap is retrieved. Step 606 returns the list of properties stored at index “object_index” in the array of properties.

For some of the graphic feedback effects to be provided by the application, the graphic object shape(s) associated with a particular object in the hitlist may be additionally retrieved (step 315 of FIG. 3).

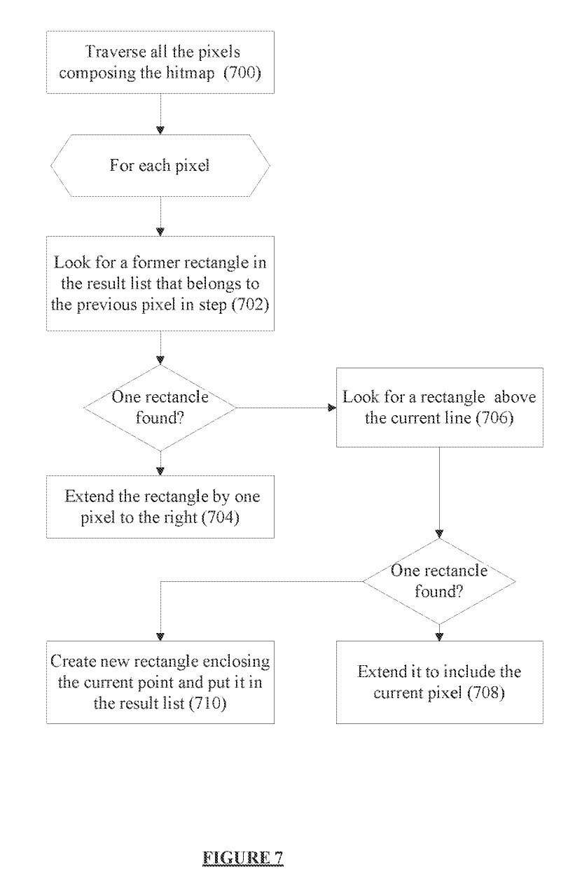

FIG. 7 shows a flowchart for retrieving graphic object shape(s).

In step 700, all the pixels composing the hitmap data structure are traversed from left to right and top to bottom. Each time a pixel is traversed, it corresponds to the index of a graphic object. This pixel is cumulated into a list of rectangles that will form the result. This accumulation is done by first looking for a rectangle (702) in the result list that has the same color value as the current pixel. If one is found, the rectangle found is extended by one pixel to the right in step 704, and the next pixel is processed. Otherwise, (706) the algorithm looks for a rectangle with the same color value as the current pixel above the current line. If a rectangle is found (707) the rectangle is extended towards the bottom by one pixel, to include the current pixel in step 708. If no rectangle covering the graphic object has been found (709), a new rectangle is created enclosing the current point and put it in the result list in step 710.

This results in a list of rectangles that can be used to build locally a graphical representation covering exactly the shape of the selected object that can be overlaid on the initial location.

An exemplary graphical representation using the resulting list of rectangles could include graphic feedback representation, such as tooltips. Tooltips on graphic elements can be provided by setting the HTML “alt” property of the image presenting the graphic representation of the application. A Javascript event handler may capture the pointer moving events. Each time the pointer moves, the event handler retrieves the object underneath the mouse and sets the “alt” or “longdesc” properties of the image element to the value held in the “tooltip” property of the corresponding object information. In accordance with exemplary embodiments of the invention, the tooltips can be displayed on top of the graphic objects as the user hovers the mouse over the graphic representation.

Another graphic feedback application could be dedicated to object highlighting and selection feedback. Object highlighting can be obtained by using SVG or VML extensions present on the client browser. When a user input is received (such as click with pointing device), the object shape is retrieved in accordance with the invention to get the list of rectangles. Some SVG or VML rectangular elements can then be added to the HTML page so as to overlay the application image. These elements can be made semi-transparent to allow the user to understand that a selection has been made.

Another example of graphic feedback application could relate to ghost shapes for drag and drop functionality. Once the shape of the object has been retrieved, the drag-and-drop operation generally could include:
displaying a highlighted version of the selected object as described above;
Installing an event handler that capture pointer move event, and translating the highlighted image by a corresponding amount as needed; for example, in a HTML page, this may be performed by setting the “onclick”, or “onmousemove” HTML properties of the image to a script implementing the wished graphic application;
Upon reception of a mouse release event, removing the graphic representation.

To implement the above application actions feedback (push button) in accordance with some aspects of the invention, graphical interaction techniques may be used to trigger the following exemplary operations on the display:
upon reception of a mouse press action on a graphic object, the object is highlighted;
upon release of the mouse button on the same graphic object, the object is de-highlighted.

If the hitlist entry for this graphic object contains a property of name “pressCallback”, then a message can be sent back to the server to be interpreted as a user action. The servlet is then able to update the graphic representation if needed, and perform some wished operation involving the related graphic object.

Other types of graphic interactions, such as gestures on the objects or contextual pop-up menus can be implemented using the same base functions, in accordance with embodiments of the invention.

Also, accessible graphical user interfaces can be generically provided by automatically sending the application data under the mouse cursor to a text-reader module. With such applications, hovering the mouse over the image would result in the name and properties of each underlying node to be outputted, such as with voice recognition technique (reading aloud the name and properties) or displayed on a specific keyboard while the cursor is hovered on the image.

The invention accordingly uses three data structures, the bitmap data structure, the hitmap data structure and the array of application object properties (Hitlist) to allow execution of any type of application on a selected object. With the invention, there is no need to encode the application domain object in the hitmap data structure, but just an index into that separately sent object. The invention allows triggering any type of predefined graphics application based on the object properties. The invention uses two indirections to encode both the object geometry but also object properties that enable a variety of graphics applications.

The invention can be realized in hardware, software, or a combination of hardware and software. The invention can be realized in a centralized fashion in one computer system, or in a distributed fashion where different elements are spread across several interconnected computer systems. Any type of computer system or other apparatus adapted for carrying out the methods described herein is appropriate. A typical combination of hardware and software can be a general purpose computer system with a computer program that, when being loaded and executed, controls the computer system such that it carries out the methods described herein.

The invention can be embedded in a computer program product, such as magnetic tape, an optically readable disk, or other computer-readable medium for storing electronic data. The computer program product can comprise computer-readable code, defining a computer program, which when loaded in a computer or computer system causes the computer or computer system to carry out the different methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The preceding description of preferred embodiments of the invention has been presented for the purposes of illustration. The description provided is not intended to limit the invention to the particular forms disclosed or described. Modifications and variations will be readily apparent from the preceding description. As a result, it is intended that the scope of the invention not be limited by the detailed description provided herein.

1. A method of executing a predefined graphics application on objects associated with a rendered image, the method comprising:
receiving an array of properties representing properties of the objects and a mapping data structure, the mapping data structure being provided to map pixel locations in the rendered image to respective indices in the array of properties; and
responsive to the reception of a user input identifying the location of a given object in the rendered image:
(i) determining from the mapping data structure an object index for the given object using the location of the given object;
(ii) retrieving properties of the given object from the array of properties at the object index; and
(iii) executing the predefined graphics application using the properties determined in step (ii) for the given object.

2. The method of claim 1, wherein the mapping data structure is received in encoded form according to a compression technique along the horizontal and vertical dimensions.

3. The method of claim 1, wherein the mapping data structure is received in compressed form, the compression using an integral factor along both horizontal and vertical dimensions.

4. The method of claim 3, wherein the step of determining the properties of the given object comprises multiplying the coordinates of the location by the integral factor.

5. The method of claim 1, further comprising:
generating the array of properties and the mapping data structure based on object attributes.

6. The method of claim 5, wherein the step of generating the array of properties and the mapping data structure comprises processing each object of the rendered image, and performing for each object the steps of:
retrieving object attributes;
storing the object attributes in an attribute table;
adding the attribute table into the array of properties, at a current index;
adding the shape of the current object into the mapping data structure using the current index as the color index; and
incrementing the current index of the array of properties.

7. The method of claim 1, wherein step (iii) of executing the predefined graphics application further uses graphic object shapes of the designated object based on the information stored in the mapping data structure.

8. The method of claim 1, wherein the predefined application is a selection application.

9. The method of claim 1, wherein the predefined application is a highlighting application.

10. A computer program product comprising a non-transitory computer-readable medium having stored thereon instructions for carrying out the steps of the method according to claim 1 when the instructions are executed on a computer device.

11. A system comprising a hardware data processor and a computer program that, when loaded and executed by the hardware data processor, controls the system to carry out the steps of the method according to claim 1.
